(19) United States
(12) Patent Application Publication
(10) Pub. No.: US 2016/0059800 A1
(43) Pub. Date: Mar. 3, 2016

(54) Air Set Device

(71) Applicant: PRETTL Electric Corp., Greenville, SC (US)

(72) Inventors: Andreas Hesse, Simpsonville, SC (US); Stefan Louis Barnes, Woodruff, SC (US)

(73) Assignee: PRETTL Electric Corp., Greenville, SC (US)

(21) Appl. No.: 14/475,630

(22) Filed: Sep. 3, 2014

(51) Int. Cl. B60R 16/02

(52) U.S. Cl. CPC B60R 16/0207

(57) ABSTRACT

A device for precisely inserting or fitting components into a sleeve, cap, or similar enclosure using air pressure to provide precise, controlled fitting of the components.

### BACKGROUND OF THE INVENTION

1) Field of the Invention

The present disclosure relates to a device for precisely inserting or fitting components into a sleeve, cap, or similar enclosure using air pressure to provide precise, controlled fitting of the components.

2) Description of Related Art

In various industries, electrical or computer-communication related wires must be gathered and specifically placed within a device to provide electricity and communication between the various sections of the device, such as between the driver controls of an automobile and the engine. For instance, most modern automobiles are replete with electronic devices, which require special wiring throughout the vehicle. This wiring provides electrical power and communication for radios, door locks, door windows, and automotive computer accessories.

Placement of wiring may be accomplished through the use of a wiring harness; a wiring configuration designed for specific wiring devices. The harness provides a single connection point for multiple wires, as well as positions and provides stability and protection for the wires. It also may form junctions for allowing electrical communication between different wiring. Wiring is a complicated process that typically requires training and retraining personnel as it is a meticulous, time-consuming job.

Electrical wiring, especially in more complex devices, requires complicated configurations. Most wiring diagrams include multiple wires where each wire is color coded to represent a specific electronic feature. The wiring harness simplifies this configuration. It provides one connection point for multiple wiring configurations. For example, most auto alarm systems, which contain complicated multiple wire configurations, are connected using a wiring harness. The harness makes installation easier because the wires join at one connection point. Without the harness each wire would need to be manually connected to each wire of the alarm; a very time consuming, costly and error-prone process.

Current devices employed for manufacturing wire harnesses cause various issues that hinder product quality and produce unnecessary waste materials. Current wire harness forming devices may bend or buckle wires during insertion, leading to faulty connections or wiring harnesses with structural defects that may later fail and impede performance. Moreover, in today's process lines, portions of the wire harness may be preassembled and delivered to a manufacturer or assembler for further processing. In these situations, a manufacturer using current assembly devices and machines must not only treat the assembly carefully, but must also deal with tolerances for devices the manufacturer did not assemble or create.

Indeed, modern applications may use a sleeve or cap to protect the wiring junction and wiring. Use of the sleeve requires “seating” the junction and wires within the sleeve and securing same to ensure the wires remain in the proper configuration. Securing the wires and junction within the harness may be accomplished by crimping the sleeve with the wires and junction positioned therein. However, this may lead to bending wires, and creating “wire memory” issues where a crimped wire carries a bend into a new section of the wiring assembly after the bend forms. Moreover, crimping is machinery intensive and requires specific, precise tooling to prevent damaging the wires and junctions. Further, crimping and current assembly methods, such as pulling a wire harness into place inside the sleeve, may hinder or damage terminal placement, bend terminals, cross wires, or damage accoutrements such as locking tabs. Moreover, securing wire harnesses in place via pulling or tugging is an inconsistent method that does not allow for precise measurements regarding wire and junction placement within a sleeve or cap.

What is needed is an improved device for wire harness assembly where harnesses may be assembled without damaging the wire assembly while also reducing waste and coming as close to zero defect production as possible.

### SUMMARY OF THE INVENTION

The above objectives are accomplished according to the present invention by providing a device for air seating components within a sleeve. The device includes a machine interface that comprises a sensor side. A sensor is included in the device for determining the position of a sleeve and a component for insertion into the sleeve with respect to the machine interface. The device also includes a holder for positioning the sleeve. A sensor is also included for determining the component is located at a preposition in the sleeve. The device also includes a sealing device configured to engage the sleeve and an air flow device. There is also a sensor for determining final positions of the sleeve and component after air flow is introduced into the sleeve.

In a further embodiment, the comprises a grommet and a ceramic cap. In another embodiment, the includes engagements for wire terminals. In a still further embodiment, the preposition in the sleeve is defined by a structure formed on an interior of the sleeve. In a yet other embodiment, the sealing device may engage the sleeve via a face seal, an inner diameter seal with respect to the sleeve, or an outer diameter seal with respect to the sleeve. In another embodiment, the air flow device may comprise an in-machine air reservoir. In a yet further embodiment, the air flow device receives air from an exterior air source. In another embodiment, the air flow device comprises a valve. In a still further embodiment, the valve is manually operated, electrically operated, or pilot air operated.

In another embodiment, an air insertion device for seating a component within a housing is provided. The air insertion device may include a sealing device, a loading port for accommodating a housing, wherein the loading port may have mating features to correspond to the shape or contour of the housing, an air flow passage, a first component detection sensor for determining the location of the component within the device, a housing detection sensor for determining the location of the housing within the loading port, and a component final position sensor for determining the location of the component within the housing.

In a further embodiment, the air sealing device forms a seal with the housing via a face seal, an inner diameter seal, or an outer diameter seal. In another embodiment, air flow through the air flow passage is measured via an air flow sensor. Still further, the pressure detected by the air flow sensor provides information regarding placement of the component within the housing. In a yet further embodiment, a timer is associated with the air flow sensor. In a still further embodiment, the air flow passage is connected to an air reservoir. In another embodiment, the air flow passage is connected to a valve. In a still yet other embodiment, the component final position sensor comprises a lever that contacts a portion of the component located within the housing.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a schematic of one embodiment of the current disclosure.

FIG. 2 illustrates a close up view of one embodiment of a sleeve, grommet and ceramic cap arrangement that may be used with the present disclosure.

FIG. 3 shows the arrangement of FIG. 2 with air pressure acting upon the sleeve, grommet, and ceramic cap.

FIG. 4 shows the arrangement of FIG. 2 after air flow has ceased with respect to the sleeve, grommet, and ceramic cap.

FIG. 5 shows another embodiment of the current disclosure positioned on a station.

FIG. 6 is a close-up view of one embodiment of the current disclosure.

FIG. 7 is a profile, cut-away view of the embodiment of FIG. 6.

FIG. 8 is a profile, cut-away view of the sensing section of the embodiment of FIG. 6.

FIG. 9 illustrates engagement and sealing of the sleeve by one embodiment of the present disclosure.

FIG. 10 shows a downward perspective view of a device of the present disclosure wherein the sealing device is not engaged with a sleeve.

FIG. 11 illustrates a method for seating components within sleeves using the devices disclosed herein.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

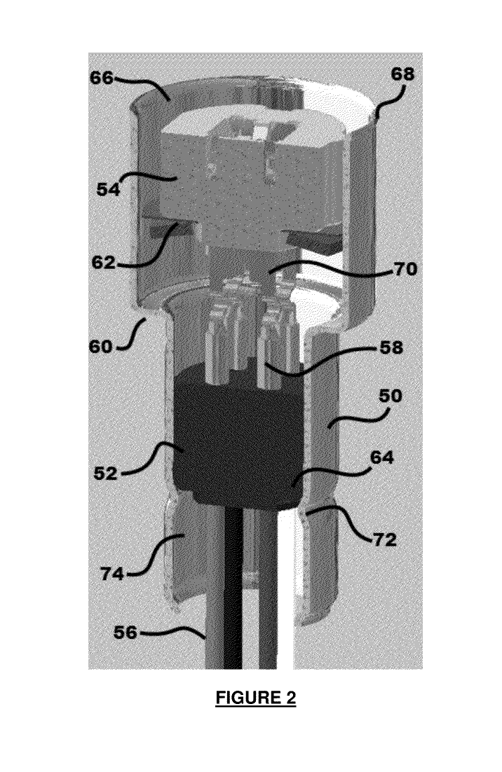

In one embodiment, the present disclosure provides a device 10 for air seating components within a sleeve. Device 10 includes a machine interface 12 that includes a sensor side 14. A sensor 16 is included on machine interface 12. Sensor 16 may comprise a sensor such as thru beam, reflective, area beam sensors, laser arrays or other non-contact sensors as known to those of skill in the art. Sensor 16 may determine the position of a sleeve 20 and a component 22 for insertion into sleeve 20. Device 10 includes a holder 24 for positioning sleeve 20. Holder 24 may engage sleeve 20 to position it within device 10. Engagement may be accomplished via frictional engagement between sleeve 20 and holder 24, magnetic engagement, or holder 24 forming a grasping element 26 to hold sleeve 20. In one embodiment, sleeve 20 may sit within holder 24, which is specifically shaped or form-fitting, in order to hold sleeve 20. A sensor 18 may be included within device 10 to determine that component 22 is located at a preposition 64, see FIG. 2, in the sleeve 20.

Referring now to FIG. 2, one embodiment of a cross-section of sleeve 50 is shown that may be processed by device 10. As FIG. 2 illustrates, sleeve 50 may be engaged with, at least, a grommet 52, a ceramic cap 54, at least one trailing wire 56, but more than one wire is considered within the present disclosure, at least one terminal 58, but additional terminals are contemplated by this disclosure, and a shelf or collar 60 for engaging with a distal end 62 of ceramic cap 54. Ceramic cap 54 may also include engagements 70 for wire terminals 58. Sleeve 50 may include an inner diameter 66 and an outer diameter 68. Sleeve 50 may also include at least one preposition structure 72 located on inner surface 74 of sleeve 50 for locating grommet 52 in preposition 64. Preposition structure 72 may be formed by crimping sleeve 50 or by otherwise forming a protrusion on inner surface 74 as known to those of skill in the art.

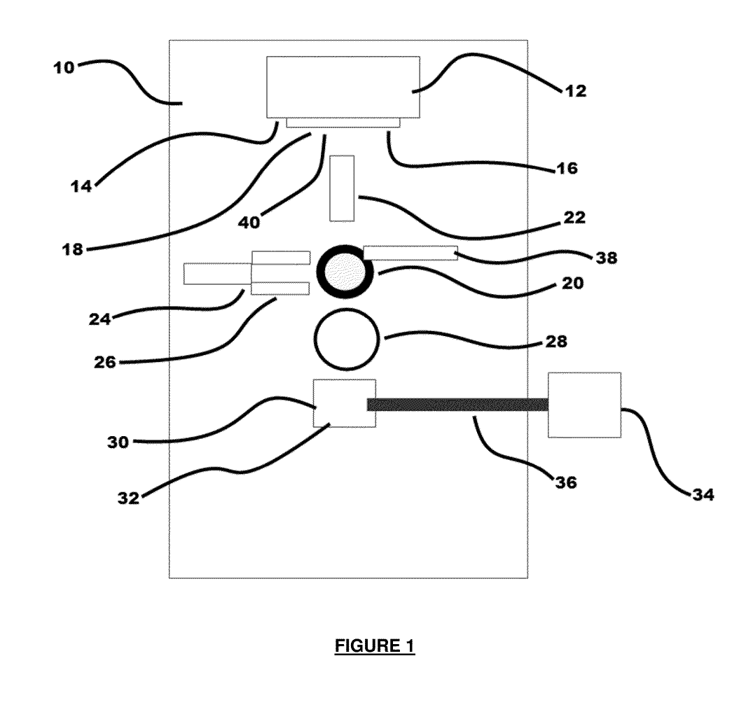

Referring again to FIG. 1, a sealing device 28 may be configured to engage sleeve 20. Various seal configurations are possible between sealing device 28 and sleeve 20 including but not limited to a face seal, an inner diameter seal with respect to sleeve 20, or an outer diameter seal with respect to sleeve 20. Engagement of sealing device 28 may be accomplished manually by pulling sealing device 28 onto sleeve 20. Engagement may also be accomplished by pneumatic action, electrical engagement, or other automation as known to those of skill in the art.

In one embodiment, air pressure may be employed to compress a plastic or rubber seal and to cause same to expand and seal around sleeve 20. These seals may be accomplished via face seal, inner diameter seal, outer diameter seal, or otherwise as known to those of skill in the art. Device 10 may also include an air flow device 30. Air flow device 30 may be integral with device 10, such as an in-device air reservoir 32. SMC, Festo, Clippard, Parker, or other air reservoirs may be used as known to those of skill in the art. The air reservoir may be sized large enough to safely handle the air flow operating ranges disclosed herein as well as provide sufficient air pressure and volume to quickly and fully seat grommet 52.

In a further embodiment, various air pressure ranges may be employed in the current disclosure. For instance, a pressure of between 0.1 to 15 Bar may be employed. In one particular embodiment, an air pressure of between 3 to 10 Bar may be employed. This pressure may be employed over a variety of time ranges, such as from 0.1 to 10 seconds. In a further embodiment, the duration of the air flow may be from 0.5 to 5 seconds. Various pressures and durations of air flow may be used depending on the device being seated. A program timer may also be incorporated to control the duration of the air flow. The timer may also be connected to a sensor such that air flow may time out if grommet 52 is not detected in a desired position after a particular air flow time has expired. Alternatively, device 10 may include an exterior air source 34 that may be connected to the device via hosing 36 or other means as known to those of skill in the art. Device 10 may also include a sensor 40 for determining the final positions of sleeve 20 and component 22 after air flow is introduced into sleeve 20. In a further embodiment, air flow device 30 may comprise a valve 38. Valve 38 may engage sealing device 28 and act upon sleeve 20 to force air into sleeve 20 to move component 22 within sleeve 20. Valve 38 may be manually operated, electrically operated, or pilot air operated. Valve 38 may be a high flow, clean room type valve as known to those of skill in the art. When air flow measurement is implemented, the valve may be a low or no leak type valve as known to those of skill in the art.

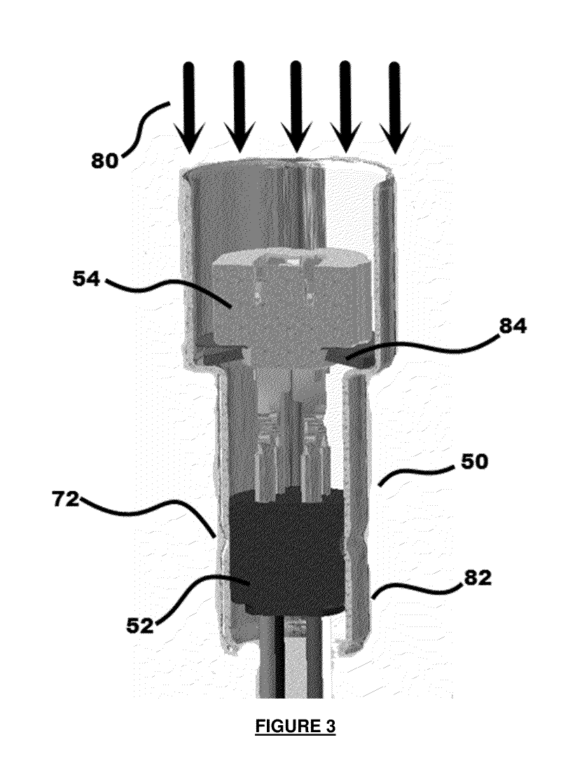

FIG. 3 shows air flow 80 acting on grommet 52 to position grommet 52 and ceramic cap 54 within sleeve 50. Air flow 80 may act to move grommet 52 past preposition structure 72 into a distal portion 82 of sleeve 50. Shelf 60 may act in concert with air flow 80 to assist with seating grommet 52 and ceramic cap 54 by engaging with a stop 84 formed in sleeve 50. In a further embodiment, various air pressure ranges may be employed in the current disclosure. For instance, a pressure of between 0.1 to 15 Bar may be employed. In one particular embodiment, an air pressure of between 3 to 10 Bar may be employed. This pressure may be employed over a variety of time ranges, such as from 0.1 to 10 seconds. In a further embodiment, the duration of the air flow may be from 0.5 to 5 seconds. Various pressures and durations of air flow may be used depending on the device being seated.

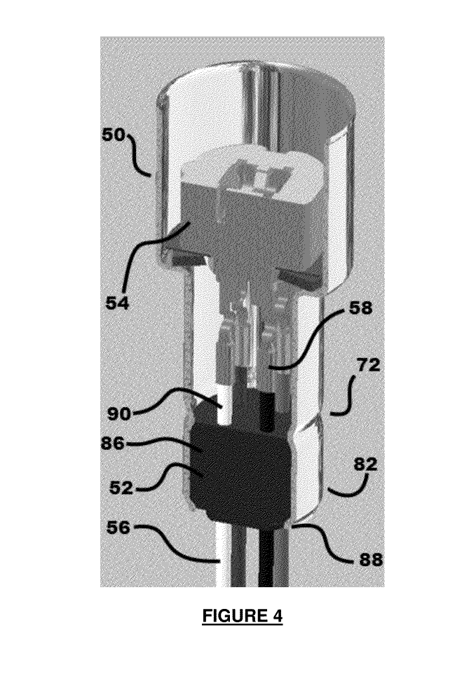

FIG. 4 shows the final position 86 of grommet 52 and ceramic cap 54 within sleeve 50 after air flow 80 has ceased being introduced into sleeve 50. As FIG. 4 illustrates, air flow 80 moved grommet 52 past preposition structure 72 into distal portion 82 of sleeve 50. In one embodiment, grommet 52 may engage a distal sleeve barrier 88 that aids with seating and achieving final position 86 of grommet 52 within sleeve 50. Movement of grommet 52 within sleeve 50 may also serve to straighten trailing wires 56 as well as terminals 58. Indeed, grommet 52 may move distally “downward” with respect to trailing wires 56 to reveal proximal portion 90 of trailing wires 56.

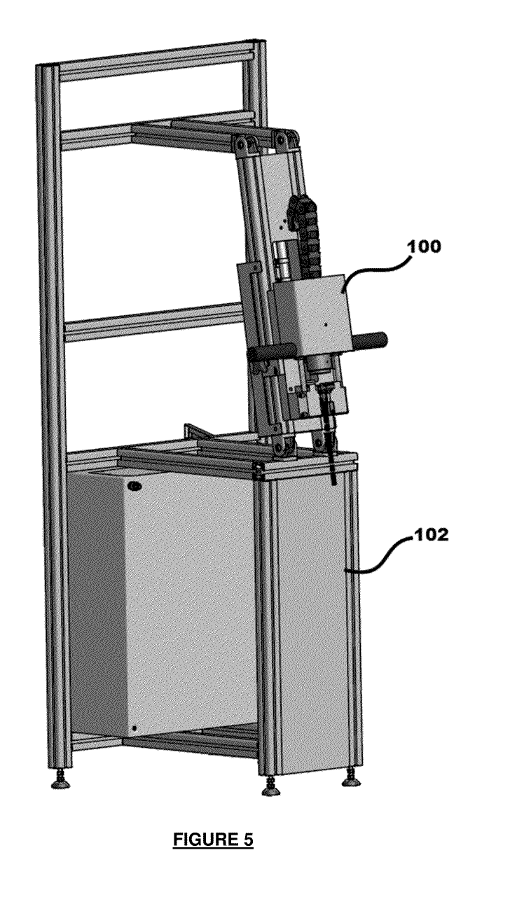

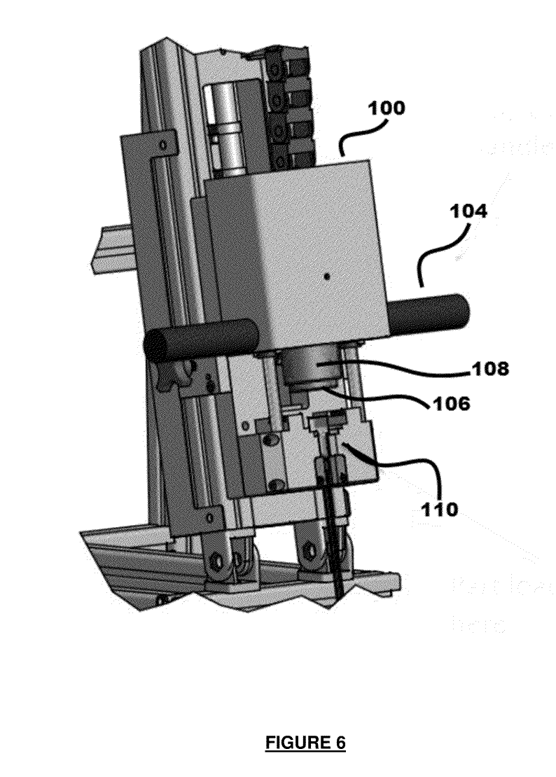

FIG. 5 shows an alternate embodiment of the invention with air insertion device 100 mounted on a station 102. FIG. 6 illustrates a close-up perspective of air insertion device 100. Device 100 may include lift/lower handles 104 that bring sealing device 106 and air flow source 108 into contact with sleeve 50, not shown. While handles 104 may be manually operated, engagement may also be mechanically, pneumatically, hydraulically, or otherwise accomplished as known in the art, to lower sealing device 106 into contact with sleeve 50. Device 100 may also include a loading port 110 for holding sleeve 50 and component 22. Further, lowering of sealing device 106 may serve to engage component 22 with sleeve 50. However, in a preferred embodiment, component 22 is engaged with sleeve 50 prior to bringing sealing device 106 into contact with sleeve 50.

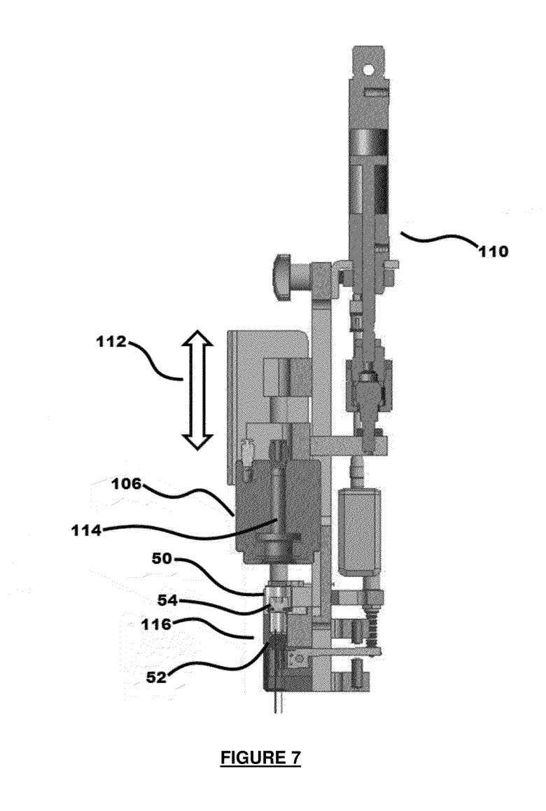

FIG. 7 is a profile, cut away view of device 100. FIG. 7 shows engagement actuator 110 that may be mechanically linked, hydraulically linked, electronically linked or otherwise as known to those of skill in the art, arranged to bring sealing device 106 into contact with sleeve 50. In one embodiment, actuator 110 may be electronically linked. Actuator 110 may also prevent sealing device 106 from prematurely engaging and disengaging by locking the position of the sealing device 106 via means as known to those of skill in the art. Both upward and downward movement, illustrated by arrow 112, is possible using actuator 110. This movement allows sealing device 106 to both engage and disengage from sleeve 50 as well as to bring air flow passage 114 into place to allow air flow to be introduced to sleeve 50. FIG. 7 also illustrates grommet position detection area 116. Within grommet position detection area 116, grommet preposition 64 and grommet final position 86 may be detected to ensure proper loading and seating of grommet 52.

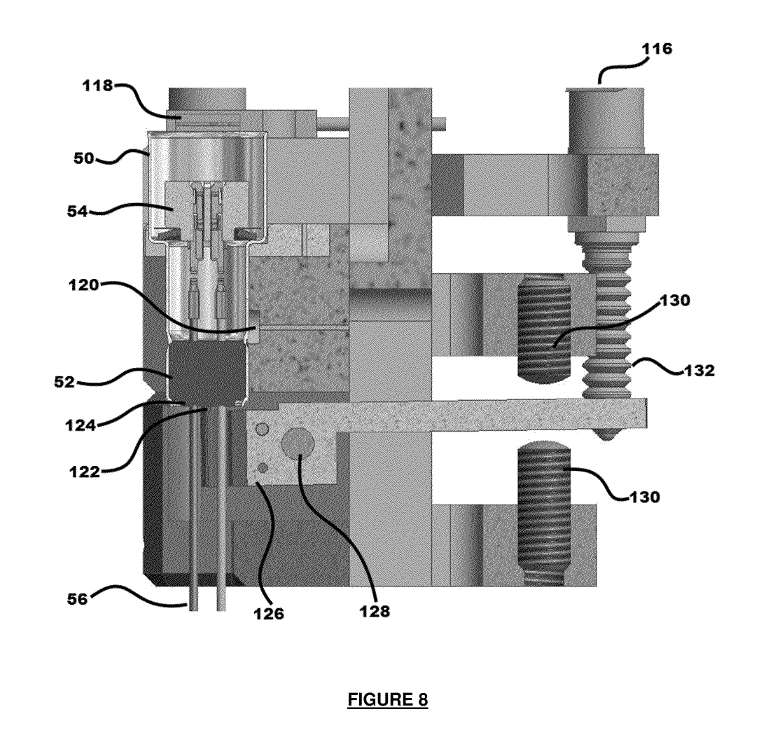

FIG. 8 illustrates a close-up, cut-away view of grommet detection area 116 of FIG. 7. Not only may the presence and locations of grommet 52 be detected, but grommet sensing area 116 may also include a cap position sensor 118 to detect the presence of ceramic cap 54. The sensor may sense the presence of the ceramic cap 54 and may detect that ceramic cap 54 is seated prior to introduction of air flow to grommet 52. In one embodiment, ceramic cap 54 should be located within sleeve 50, not protruding above same, prior to air flow. Beam sensors, reflective sensors, area beam sensors, laser arrays, etc., as known to those of skill in the art may be used to detect the presence of ceramic cap 54. Another sensor, part presence sensor 120 may serve to detect the that sleeve 50 has been placed within device 100. Sensor 120 may also detect that the sleeve is placed level in device 100. Sensor 120 may comprise a proximity switch, a reflective optical beam sensor, mechanical switch, laser sensor, or other sensing means as known to those of skill in the art. Grommet detection area 116 may include a grommet contact point 122 that contacts distal surface 124 of grommet 52. Grommet contact point 122 may formed on a grommet contact lever 126 that may be placed on a pivot 128. Grommet contact point 122 may also be a switch pin, a limit switch, a laser based distance measurement, a profiling laser system or other means as known to those of skill in the art.

In a further embodiment, grommet contact lever 126 may be positioned between travel limits 130 that limit the vertical movement of grommet contact lever 126. Movement of grommet contact linear may be measured by various means known to those in the art. However, in a preferred embodiment, a linear variable differential transformer (LVDT) 132, also called just a differential transformer, linear variable displacement transformer, or linear variable displacement transducer, may be employed to measure linear displacement and the position of grommet contact lever 126 within grommet detection area 116. This allows for ascertaining the position of grommet contact lever 126, and thereby the position of grommet 52 when grommet 52 is in contact with grommet contact lever 126. Thus, grommet detection area 116 allows a user to ascertain the location of grommet 52 within device 100. By knowing the location of grommet 52, one can tell if grommet 52 was seated correctly in sleeve 50. In another embodiment, after air flow has ceased, lever 126 may prevent the grommet from protruding too far out of sleeve 50 as travel of lever 126 is prevent by travel limits 130.

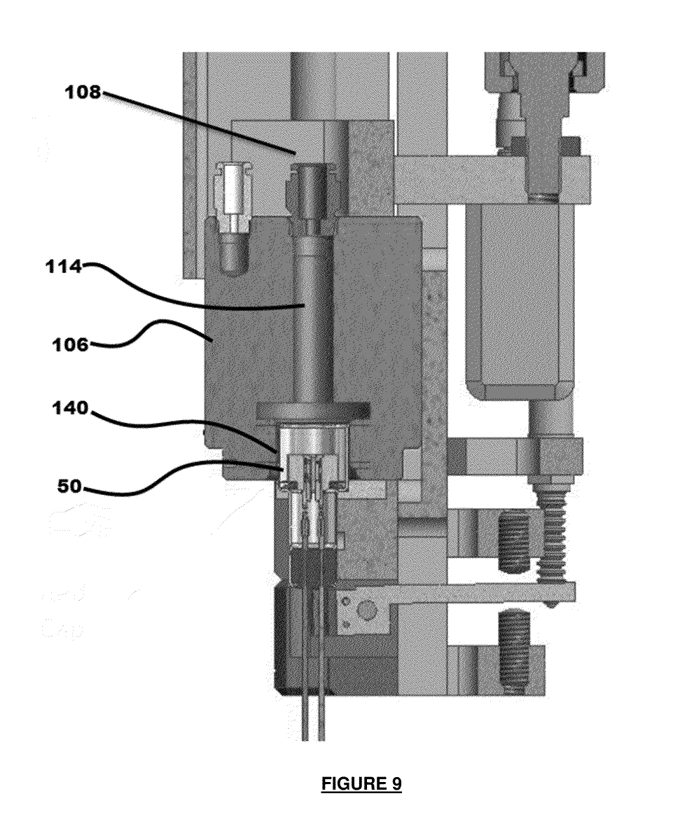

FIG. 9 shows a close up, cut away view of sealing device 106 engaged with sleeve 50 to create seal 140. Air flow source 108 may be monitored, such as via a pressure switch, not shown, to determine the pressure flowing through air flow passage 114. Monitoring or measuring air flow source 108 may help detect issues with grommet 52 such as not seating level, physical defects in grommet 52, defects in sleeve 50, etc. Ways of measuring include a mass-flow gauge, a pressure transducer coupled with a known starting volume (pressure decay) or via other means as known to those of skill in the art. Accurate pressure measurement helps to precisely determine the air flow introduced to sleeve 50. By knowing this, it is possible to verify the air flow for each sleeve. This may provide a reproducible process for accurately, precisely and constantly seating component 22 within sleeve 50 over a multitude of introduction events. This improves seating, allows for consistent placement and does away with the problems experienced in prior art systems where component 22 may be positioned within sleeve 50 by pulling on trailing wires 56; thereby possible causing shorts, wire memory issues, disconnecting wires from terminals 58, crimping wires, etc.

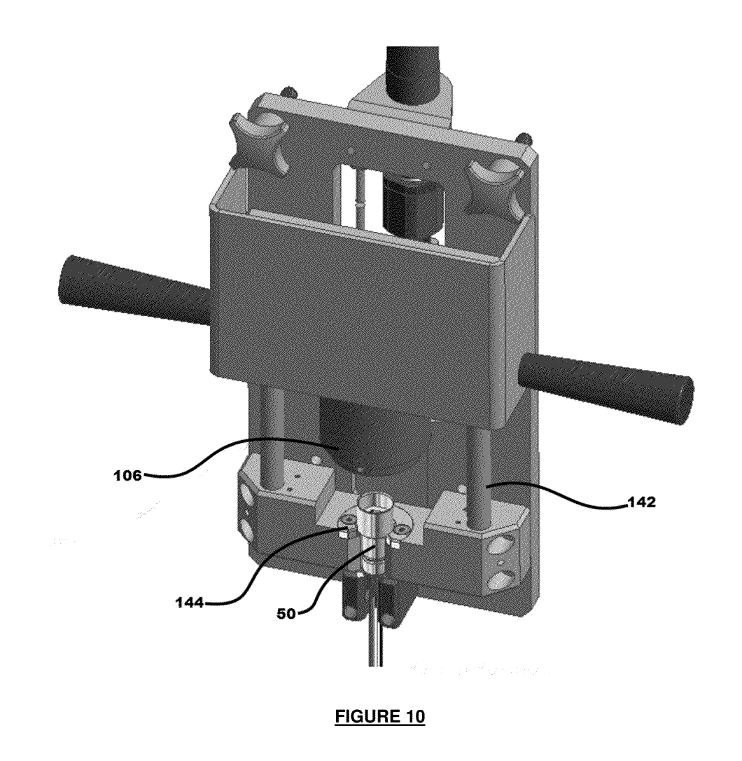

FIG. 10 shows a downward perspective view of device 100 wherein sealing device 106 is not engaged with sleeve 50. Alignment guides 142 serve to ensure consistent placement and engagement of sealing device 106 with sleeve 50. Sleeve 50 may be maintained in place by sleeve holder 144. Sleeve holder 144 may engage sleeve 50 via frictional engagement, magnetic engagement, etc., as known to those of skill in the art. Additionally, sleeve holder 144 may be formed with a matching geometry that compliments sleeve 50 in order to secure same. For instance, sleeve holder 144 may define a cavity shaped to match the profile of sleeve 50.

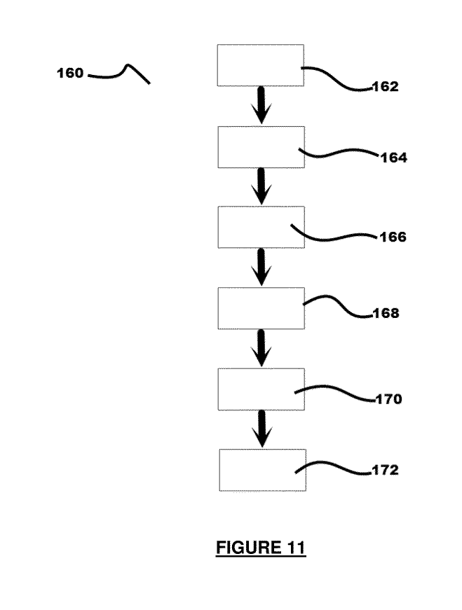

Although devices for seating components within sleeves are herein disclosure, methods for so seating components are also considered within the concept of this disclosure. FIG. 11 illustrates a method 160 of using air to seat components within a sleeve. At step 162, a sleeve is introduced alone with a component later introduced, or both are introduced in an engaged configuration, to a machine interface. Step 164 includes sensing the relative positions of the sleeve and component with respect to one another and the machine interface. Step 164 may also include placing the component in a preposition with respect to the sleeve or this engagement may be accomplished in a separate step. At step 166, the sleeve is sealed. At step 168, air flow is introduced into the sleeve to seat the component within the sleeve. Step 170 includes sensing the final position of the component within the sleeve. At step 172, the sleeve is released from the machine interface.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A device for air seating components within a sleeve comprising:
a machine interface comprising a sensor side;
a sensor for determining the position of a sleeve and a component for insertion into the sleeve;
a holder for positioning the sleeve;
a sensor for determining the component is located at a preposition in the sleeve;
a sealing device configured to engage the sleeve;
an air flow device; and
a sensor for determining final positions of the sleeve and component after air flow is introduced into the sleeve.

2. The device for air seating components within a sleeve of claim 1, wherein the component comprises a grommet and a ceramic cap.

3. The device for air seating components within a sleeve of claim 2, wherein the ceramic cap includes engagements for wire terminals.

4. The device for air seating components within a sleeve of claim 1, wherein the preposition in the sleeve is defined by a structure formed on an interior of the sleeve.

5. The device for air seating components within a sleeve of claim 1, wherein the sealing device engages the sleeve via a face seal, an inner diameter seal with respect to the sleeve, or an outer diameter seal with respect to the sleeve.

6. The device for air seating components within a sleeve of claim 1, wherein the air flow device comprises an in-machine air reservoir.

7. The device for air seating components within a sleeve of claim 1, wherein the air flow device receives air from an exterior air source.

8. The device for air seating components within a sleeve of claim 1, wherein the air flow device comprises a valve.

9. The device for air seating components within a sleeve of claim 8, wherein the valve is manually operated, electrically operated, or pilot air operated.

10. An air insertion device for seating a component within a housing comprising:
a sealing device;
a loading port for accommodating a housing;
an air flow passage;
a first component detection sensor for determining the location of the component within the device;
a housing detection sensor for determining the location of the housing within the loading port; and
a component final position sensor for determining the location of the component within the housing.

11. The air insertion device for seating a component within a housing of claim 10, wherein the sealing device forms a seal with the housing via a face seal, an inner diameter seal, or an outer diameter seal.

12. The air insertion device for seating a component within a housing of claim 10, wherein air flow through the air flow passage is measured via an air flow sensor.

13. The air insertion device for seating a component within a housing of claim 12, wherein the pressure detected by the air flow sensor provides information regarding placement of the component within the housing.

14. The air insertion device for seating a component within a housing of claim 12, wherein a timer is associated with the air flow sensor.

15. The air insertion device for seating a component within a housing of claim 10, wherein the air flow passage is connected to an air reservoir.

16. The air insertion device for seating a component within a housing of claim 10, wherein the air flow passage is connected to a valve.

17. The air insertion device for seating a component within a housing of claim 10, wherein the component final position sensor comprises a lever that contacts a portion of the component located within the housing.

18. The air insertion device for seating a component within a housing of claim 10, wherein the loading port includes mating features that correspond to the shape of the housing.

19. A method for using air to seat components within a sleeve comprising:
introducing a sleeve and component to a machine interface;
sensing the relative positions of the sleeve and component with respect to one another and the machine interface;
placing the component in a preposition with respect to the sleeve;
sealing the sleeve;
introducing air flow into the sleeve to seat the component within the sleeve;
sensing the final position of the component within the sleeve; and
releasing the sleeve.
